(19) United States
(12) Patent Application Publication
(10) Pub. No.: US 2015/0215666 A1
(43) Pub. Date: Jul. 30, 2015

(54) ELECTRONIC DISPLAYS WITH USER AGENTS FOR MANAGING CANVASES ON THE DISPLAYS

(71) Applicant: Sony Corporation, Tokyo (JP)

(72) Inventors: Brant Candelore, San Diego, CA (US); Graham Clift, Poway, CA (US); Kazumoto Kondo, Kawasaki (JP); Steven Richman, San Diego, CA (US); Fred Zustak, Poway, CA (US)

(73) Assignee: Sony Corporation, Tokyo (JP)

(21) Appl. No.: 14/168,470

(22) Filed: Jan. 30, 2014

(51) Int. Cl. H04N 21/431; G06F 3/0484; H04N 21/643; H04N 21/462; H04N 21/81; H04N 21/485; H04N 21/478; H04N 21/4782; H04N 21/475; H04N 21/466; G06F 3/0482; H04N 21/439

(52) U.S. Cl. CPC H04N 21/4314; G06F 3/0482; G06F 3/04842; H04N 21/64322; H04N 21/4622; H04N 21/4396; H04N 21/4858; H04N 21/4852; H04N 21/4781; H04N 21/4782; H04N 21/475; H04N 21/466; H04N 21/8173

(57) ABSTRACT

An electronic visual display includes a screen having a plurality of canvases each configured to display content from at least one content source. The content displayed on each one of the plurality of canvases may be independent of the content displayed on each other one of the plurality of canvases. The display also includes a single software-implemented user agent adapted to receive user selections associated with at least one of the canvases and configured to manage each of the plurality of canvases independently of one another according to the user selections. The user agent is configured to prevent the canvases from overlaying any portion of one another.

### FIELD

This invention relates to electronic display screens, and more specifically, to display screens having one or more user agents managing one or more canvases on the display screens.

### BACKGROUND

Big screen and Internet-enabled television sets are becoming increasingly popular because they may accommodate multiple canvases or windows that allow the users to simultaneously view and/or interact with multiple sources of content. For example, some televisions are provided with the picture-in-picture capability that allows a user to simultaneously display two different programs on the television screen. Monitors connected to computers running an operating system such as Windows or Mac OS may display multiple windows each having a different type of content. The windows are permitted to be independently controlled, moved and resized on the computer monitors and may be tiled or positioned to overlay one another.

Televisions are typically controlled with a remote control and personal computers are typically controlled with a mouse and/or keyboard and each window on the display is controlled independently of the other windows on the display. The presently available multiple screen displays typically treat the screen of the display as one canvas and provide the user with multiple windows that compete for space on the screen and are capable of overlaying and occluding one another. Accordingly, a display is needed having the capability of displaying multiple canvases that are independently controlled via one or more use agents and prevented from occluding one another to guarantee a certain level of service to a user.

### SUMMARY

The present invention satisfies this need. In one embodiment, an electronic visual display includes a screen with a plurality of canvases each configured to display content from at least one content source. The content displayed on each one of the plurality of canvases is independent of the content displayed on each other one of the plurality of canvases. The display also includes a single software-implemented user agent adapted to receive user selections associated with at least one of the canvases and configured to manage each of the plurality of canvases independently of one another according to the user selections. The user agent is configured to prevent the canvases from overlaying any portion of one another.

In an approach, the user agent is a web browser agent.

In one approach, the user agent is adapted to arrange the canvases on the screen in a tiled arrangement where the canvases are all identical in size.

In another approach, the user agent is adapted to restrict any one of the canvases to only display one type of content.

In yet another approach, the user agent is adapted to designate one of the canvases as a main canvas and at least one other canvas as a secondary canvas.

The user agent may be adapted to independently control audio output of each of the canvases.

The user agent may be adapted to zoom in on the content on at least one of the canvases. The user agent may be adapted to simultaneously resize at least two canvases.

In one approach, the user agent is adapted to permit a first user to select personalized settings for at least one of the canvases and a second user to select personalized settings for at least another one of the canvases. The personalized settings selected by the first and second users may be independent from one another.

A method of managing the plurality of canvases on the aforementioned display includes: associating a set of preferences with at least two of the canvases by entering selections into the user agent; and implementing, via the user agent, the preferences associated with a respective one of the canvases independently of the other canvases to manage at least one of video display and audio output of the respective one of the canvases.

An electronic visual display includes a screen including a plurality of canvases each configured to display content from at least one content source and a plurality of software-implemented user agents. The content displayed on each one of the plurality of canvases is independent of the content displayed on each other one of the plurality of canvases. Each of the user agents is adapted to receive user selections associated with a respective one of the canvases and configured to manage the respective one of the canvases independently of any other canvas on the screen according to the user selections. The user agents are configured to prevent the canvases from overlaying any portion of one another.

In an approach, each of the user agents is a web browser user agent.

In one approach, each of the user agents is adapted to independently arrange the respective one of the canvases such that the canvases are positioned on the screen in a tiled arrangement.

In another approach, each of the user agents is adapted to restrict the respective one of the canvases to only display one type of content.

In yet another approach, one of the user agents is adapted to designate the respective one of the canvases as a main canvas and another of the user agents is adapted to designate another of the canvases as a secondary canvas.

In an approach, each of the user agents is adapted to independently control audio output of the respective one of the canvases.

Each of the user agents may be adapted to independently zoom in on the content on the respective one of the canvases. Each of the user agents may be adapted to resize the respective one of the canvases.

In one approach, a first of the user agents is adapted to permit a first user to select personalized settings for a first of the canvases and a second of the user agents is adapted to permit a second user to select personalized settings for a second of the canvases. The personalized settings selected by the first and second users may be independent from one another.

A method of managing the plurality of canvases on the aforementioned display includes: associating a set of preferences with a first of the canvases by entering selections into the first user agent associated with only the first of the canvases; and implementing, via the first user agent, the preferences associated with the first of the canvases independently of the other canvases to manage at least one of video display and audio output of the first of the canvases.

The methods described in the present application provide numerous advantages over the presently used systems and methods, which will be appreciated by those of ordinary skill in the art with reference to the following drawings, detailed description, and claims.

### BRIEF DESCRIPTION OF THE DRAWINGS

FIG. 1 is a schematic diagram of a system where content is delivered to a display screen from multiple sources and a display screen of an electronic visual device showing four canvases receiving content from the four distinct sources and including a browser user agent that controls all four canvases; and

FIG. 2 is a schematic diagram of a system where content is delivered to a display screen from multiple sources and a display screen of an electronic visual device showing four canvases receiving content from the four distinct sources and including four separate browser user agent each independently controlling one of the four canvases.

### DETAILED DESCRIPTION

Reference will now be made in detail to the present preferred embodiments of the invention, examples of which are illustrated in the accompanying drawings.

Generally, an electronic visual display includes a screen with a plurality of canvases each configured to display content from at least one content source. The display may include a single software-implemented user agent adapted to receive user selections associated with at least one of the canvases and configured to manage each of the plurality of canvases independently of one another according to the user selections or a plurality of software-implemented user agents each adapted to receive user selections associated with a respective one of the canvases and configured to manage the respective one of the canvases independently of one another according to the user selections. The user agent or user agents are adapted to prevent the canvases from overlaying or occluding any portion of one another.

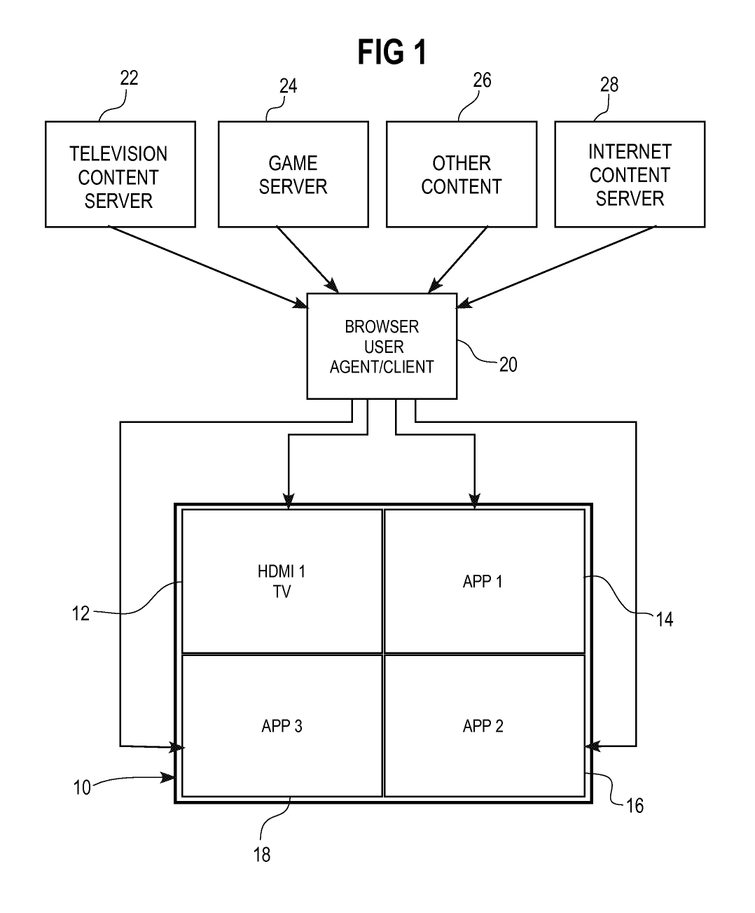

With reference to FIG. 1, an exemplary visual display 10 includes several canvases 12, 14, 16, and 18 available to one or more users to enjoy various different functionalities on the display 10. An exemplary suitable electronic display 10 may be in the form of an electronic device such as a television, computer monitor, tablet computer, a mobile communication device, or the like. The display 10 may be an LCD, LED, OLED, or plasma television display having HD (1920×1080), 4K (3840×2160), or 4K2K (4096×2160) resolution. The electronic display 10 has been shown in FIGS. 1-3 as having four discrete non-overlapping canvases 12, 14, 16, and 18, but it will be appreciated that the display 10 can have any number of canvases suitable for the size of the display 10. For example, an 84 inch display may include four canvases as shown in FIG. 1, a 120 inch display may include six or eight canvases, and a 360 inch display may include 9, 16, or 25 canvases.

Each of the canvases 12, 14, 16, and 18 of the display 10 allows for dynamic, scriptable rendering of shapes and bitmap images. For example, the canvases 12, 14, 16, and 18 may be used in building graphs, animations, games, and image composition, rendering video content, and/or other such content. In some implementations, the canvases 12, 14, 16, and 18 represent a low level, procedural model that updates a bitmap and does not have a built-in scene graph. In one approach, the canvases 12, 14, 16, and 18 are utilized with HTML5. In some implementations, a canvas 12, 14, 16, 18 consists of a drawable region defined in HTML code with dimension attributes. Code may access the area through a set of drawing functions similar to those of other common two-dimensional APIs, which can allow for dynamically generated graphics. In some approaches, the code can be JavaScript code or other relevant code. The canvases 12, 14, 16, 18 may be raster-based and distinct from the vector-based scalable vector graphics (SVG) often used in website content to display graphics and/or drawings.

By way of example shown in FIG. 1, the first canvas 12 represents a first session that includes content received from a television programming broadcasting source, such as the television content server 22. The first canvas 12 may receive content from a set top box that receives the television broadcast from a cable head end and is connected to the visual display 10 via an HDMI port. The first canvas 12 is not limited to receiving content from the television content server 22, but can receive content from any one of the television content server 22, game server 24, other content 26, and Internet content server 28.

The television content server 22 may be, for example, a cable head end, or an earth station of a satellite television service provider. The game server 24 may be any server configured to transmit game data (e.g., multiplayer Internet-based video games) to the display 10. Other content 26 may be, for example, a video game console, a DVD player, a media player device, or the like. The Internet content server 28 may be any server connected to the World Wide Web that may transmit the content of web pages to the display 10.

The second, third, and fourth canvases 14, 16, and 18 have been shown in FIG. 1 as displaying APP 1, APP 2, and APP 3, respectively, but the canvases 14, 16, and 18 are not limited to receiving and displaying “applications.” By way of example only, each of the canvases 12, 14, 16, 18 may simultaneously and independently represent sessions including different types of content (e.g., content received from any one of the television content server 22, game server 24, other content 26, and internet content server 28). For instance, each of the canvases 12, 14, 16, and 18 may independently display live television programming, video-on-demand movies, Internet content such as a browser and web pages, streaming radio/video content, interactive games, (via a local CD-ROM or hard drive or from a game server), JAVA applications, any other applications, or the like services.

In the embodiment shown in FIG. 1, the display 10 includes a software-implemented event manager, client, or user agent such as a browser user agent 20. The user agent 20 may be in the form of software or a browser agent stored in the memory of the display 10, a set-top box, a gaming console, a media player device, or a remote server, and configured to receive user inputs, preferences, settings, and templates that govern relative sizes, locations, and priorities of the canvases 12, 14, 16, 18 on the display 10. For example, the user agent 20 may be in the form of a browser window and/or provide an icon-based selection menu on the display 10 that permits the user to enter inputs, preferences, and/or settings via a remote control or a touch screen interface. In one approach, the user agent 20 may be configured to include a user profile such that the display 10 is personalized by having the canvases 12, 14, 16, 18 located and sized in accordance with user-specific preferences whenever the display 10 is turned on by a respective user.

For example, a user may select user agent menu options requiring that the canvases 12, 14, 16, and 18 are tiled and equally sized whenever the display 10 is turned on, or that only canvases 12 and 14 are visible on the display 10 and regardless of the resizing and positioning of the canvases 12 and 14, that canvas 12 is always larger than canvas 14 and will be always on the left of canvas 14. With such options set by the user, the user agent 20 manages the canvases 12, 14, 16, 18 such that no matter how the canvases 12, 14, 16, 18 are resized or moved on the display 10, the canvas 12 remains larger than the canvas 14 and is located on the left of the canvas 14.

As shown in FIG. 1, the canvases 12, 14, 16, and 18 are distinct from one another. The canvases 12, 14, 16, and 18 are positioned on the screen of the display 10 such that the canvases 12, 14, 16, 18 do not overlay or occlude one another. In one approach, the user agent 20 of the display 10 is configured to prevent the canvases 12, 14, 16, and 18 from occluding any portion of one another. For example, the user agent 20 of the display 10 is configured (e.g., via manually entered user preferences or default settings) such that when one of the canvases (e.g., 12) is resized, the other three of the canvases (e.g., 14, 16, and 18) are automatically resized accordingly. In one approach, the first canvas 12 may be increased in size by a user via a remote control (not shown) and, in response to the first canvas 12 being resized, one, two, or all of the other canvases 14, 16, and 18 are simultaneously reduced in size to accommodate for the size increase of the first canvas 12.

When a user watching television programming shown on the canvas 12 desires to increase the size of any one of the canvases, in particular, the canvas 12, the user may resize the canvas 12 using a remote control, mouse, keyboard, touch screen controls, or the like. Since the user agent 20 is preferably set to prevent the canvases 12, 14, 16, 18 from overlaying or occluding one another in whole or in part, as the canvas 12 is increased in size to a point where the canvas 12 would overlay any of the canvases 14, 16, and 18, the user agent is 20 is configured to automatically resize one or more of the canvases 14, 16, 18 on the display 10 in real time to accommodate for the increase in the size of the canvas 12. This provides an advantage over existing displays, which may permit the display of multiple windows where each window may be independently resized but do not automatically resize the windows when one window is resized, requiring a user to expend time and effort to manually resize each of the windows to an appropriate size.

The user agent 20 of the display 10 is configurable (by a local user or from a remote server) in a variety of ways to independently control each one of the canvases 12, 14, 16, and 18 (e.g., by controlling the options relating to the size of the screen and/or display of the content, and/or options relating to controlling the playback of the content). In one form, the user agent 20 of the display 10 may be configured (e.g., via manually entered user preferences or default settings) such that any one or more of the canvases 12, 14, 16, 18 may receive and display only one type of content, for example, only television content or only JAVA-based applications, or only other applications. The user agent 20 may also be configured (e.g., via manually entered user preferences or default settings) such that one of the canvases 12, 14, 16, and 18 is designated as a main or primary canvas, ensuring that the primary canvas always remains visible on the display 10 and is optionally always the largest one of the canvases on the display 10.

The user agent 20 may also independently control audio output of each one of the canvases 12, 14, 16, and 18. For example, the user agent 20 may be configured to permit the user to manually select which one of the canvases 12, 14, 16, and 18 is heard through the speakers internal to the display 10 by positioning a cursor over the respective one of the canvases 12, 14, 16, and 18.

In one preferred form, the user agent 20 may pair one or more of the canvases 12, 14, 16, 18 on the screen of the display 10 and manage two canvases on the display 10 based on the two canvases being paired to each other. For example, the user agent 20 may recognize two canvases 12 and 14 as being paired based on the content displayed on the canvases 12 and 14. In one approach, the content (e.g., a television or video program) running and displayed on the canvases 12 and 14 may include one or more markers that permit automatic content recognition. Such markers may be video content or audio content-specific. In another approach, a user may manually set the user agent 20 to recognize that the canvases 12 and 14 are a pair having associated content.

Associated content may be content that is related by subject matter. For example, a user watching one football game on the canvas 12 may be presented with a real time box score of the game or a touchdown scored in another football game on the paired canvas 14. Alternatively, the user may be presented with a targeted e-commerce opportunity or advertisement on the paired canvas 14. In another alternative, the content on the canvas 12 may include embedded web links, interactive overlays, hot spots, and/or icons that are selectable by a user using a remote control, a mouse, or a keyboard, and the selecting of which generates content associated with the selected web link, overlay, hot spot, or icon on the paired canvas 14.

Upon recognition of the canvases 12 and 14 as a pair, the user agent 20 may manage the canvases 12 and 14 differently from the unassociated canvases 16 and 18. In one approach, the user agent 20 may manage the canvases 12, 14, 16, and 18 such that the paired or linked canvases 12 and 14 are larger than any of the other canvases 16 and 18, and both remain visible on the screen of the display 10 whenever any one canvases 12, 14, 16, and 18 are resized to a size where one or more of the other canvases can no longer fit on the screen of the display 10. The user agent 20 may also be configured to maintain a preset size ratio between the paired canvases 12 and 14.

In one approach, any one or more of the canvases 12, 14, 16, and 18 may be copied or transferred from the display 10 to a screen of another electronic device in communication with the display 10. By way of example only, the display 10 may be a big screen television set and the other electronic device may be a personal laptop computer, and a user leaving the house may transfer any one or more of the canvases 12, 14, 16, and 18 from the display 10 onto the screen of the laptop computer so that the user, or the user's child can continue watching a television shows or cartoon while being away from home. It will be appreciated that instead of a personal laptop computer, the canvases 12, 14, 16, and 18 may be transferred to any other suitable electronic device such as a tablet computer or a cellular phone.

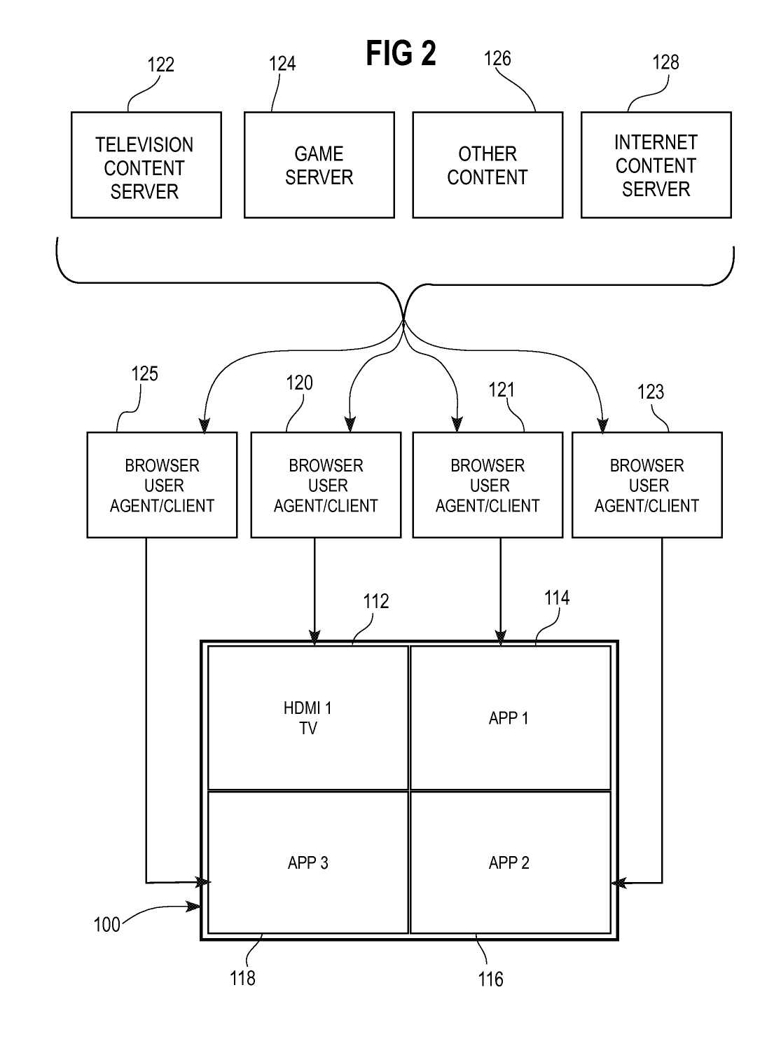

FIG. 2 shows an alternative embodiment where instead of one user agent 20 independently controlling each of the canvases 12, 14, 16, and 18, the display 10 includes four independent user agents 120, 121, 123, and 125 each independently controlling the canvas 112, 114, 116, and 118, respectively. Each of the user agents 120, 121, 123, and 125 may independently control each respective canvas 112, 114, 116, and 118 in a substantially similar way to that described above in reference to the user agent 20 (e.g., by controlling the options relating to the size of the canvas and/or display of the content, and/or options relating to the playback of the content).

By way of example shown in FIG. 2, the first canvas 112 represents a first session that includes content received from a television programming broadcasting source, such as the television content server 122, the second canvas 114 represents a second session that includes content received from a game source, such as the game server 124, the third canvas 116 represents a third session that includes content received from a number of sources described above, such as the other content 126, and the fourth canvas 118 represents a fourth session that includes content received from an Internet source, such as the Internet content server 128. As described above, none of the canvases 112, 114, 116, 118 is limited to receiving content from only one of the content sources 122, 124, 126, 128, but can receive content from any one of the television content server 122, game server 124, other content (e.g., any executable application) 126, and Internet content server 128.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. An electronic visual display comprising:
a screen including a plurality of canvases each configured to display content from at least one content source, the content displayed on each one of the plurality of canvases being independent of the content displayed on each other one of the plurality of canvases; and
a single software-implemented user agent adapted to receive user selections associated with at least one of the canvases and configured to manage each of the plurality of canvases independently of one another according to the user selections, the user agent being configured to prevent the plurality of canvases from overlaying any portion of one another.

2. The display of claim 1, wherein the user agent is a web browser agent.

3. The display of claim 1, wherein the user agent is adapted to arrange the canvases on the screen in a tiled arrangement where the canvases are all identical in size.

4. The display of claim 1, wherein the user agent is adapted to restrict any one of the canvases to only display one type of content.

5. The display of claim 1, wherein the user agent is adapted to designate one of the canvases as a main canvas and at least one other canvas as a secondary canvas.

6. The display of claim 1, wherein the user agent is adapted to independently control audio output of each of the canvases.

7. The display of claim 1, wherein the user agent is adapted to zoom in on the content on at least one of the canvases.

8. The display of claim 1, wherein the user agent is adapted to simultaneously resize at least two canvases.

9. The display of claim 1, wherein the user agent is adapted to permit a first user to select personalized settings for at least one of the canvases and a second user to select personalized settings for at least another one of the canvases, the personalized settings selected by the first and second users being independent from one another.

10. A method of managing the plurality of canvases on the display of claim 1, the method comprising:
associating a set of preferences with at least two of the canvases by entering selections into the user agent; and
implementing, via the user agent, the preferences associated with a respective one of the canvases independently of the other canvases to manage at least one of video display and audio output of the respective one of the canvases.

11. An electronic visual display comprising:
a screen including a plurality of canvases each configured to display content from at least one content source, the content displayed on each one of the plurality of canvases being independent of the content displayed on each other one of the plurality of canvases; and
a plurality of software-implemented user agents, each of the user agents adapted to receive user selections associated with a respective one of the canvases and configured to manage the respective one of the canvases independently of any other canvas on the screen according to the user selections, the user agents being configured to prevent the plurality of canvases from overlaying any portion of one another.

12. The display of claim 11, wherein each of the user agents is adapted to prevent the respective one of the canvases from overlaying another of the canvases.

13. The display of claim 11, wherein each of the user agents is adapted to independently arrange the respective one of the canvases such that the canvases are positioned on the screen in a tiled arrangement.

14. The display of claim 11, wherein each of the user agents is adapted to restrict the respective one of the canvases to only display one type of content.

15. The display of claim 11, wherein one of the user agents is adapted to designate the respective one of the canvases as a main canvas and another of the user agents is adapted to designate another of the canvases as a secondary canvas.

16. The display of claim 11, wherein each of the user agents is adapted to independently control audio output of the respective one of the canvases.

17. The display of claim 11, wherein each of the user agents is adapted to independently zoom in on the content on the respective one of the canvases.

18. The display of claim 11, wherein each of the user agents is adapted to resize the respective one of the canvases.

19. The display of claim 11, wherein a first of the user agents is adapted to permit a first user to select personalized settings for a first of the canvases and a second of the user agents is adapted to permit a second user to select personalized settings for a second of the canvases, the personalized settings selected by the first and second users being independent from one another.

20. A method of managing the plurality of canvases on the display of claim 11, the method comprising:
associating a set of preferences with a first of the canvases by entering selections into the first user agent associated with only the first of the canvases; and
implementing, via the first user agent, the preferences associated with the first of the canvases independently of the other canvases to manage at least one of video display and audio output of the first of the canvases.
